(19) United States
(12) Patent Application Publication
(10) Pub. No.: US 2026/0341290 A1
(43) Pub. Date: Oct. 29, 2026

(54) SPEECH DATA PROCESSING METHOD, SPEECH DATA PROCESSING DEVICE, ELECTRONIC DEVICE, AND COMPUTER-READABLE STORAGE MEDIUM

(71) Applicant: UBTECH ROBOTICS CORP LTD, Shenzhen (CN)

(72) Inventors: CHAOFENG CHEN, Shenzhen (CN); Zehong Zheng, Shenzhen (CN); Baiyu Pan, Shenzhen (CN)

(21) Appl. No.: 19/432,256

(22) Filed: Dec. 24, 2025

(30) Foreign Application Priority Data
Dec. 30, 2024 (CN) 202411993615.9

(51) Int. Cl. G10L 21/013; G10L 15/22; G10L 15/26; G10L 19/16; G10L 25/30; G10L 25/60

(52) U.S. Cl. CPC G10L 21/013; G10L 15/22; G10L 15/26; G10L 19/173; G10L 25/30; G10L 25/60; G10L 2021/0135

(57) ABSTRACT

A speech data processing method, a speech data processing device, an electronic device, and a non-transitory computer-readable storage medium are provided. The speech data processing method includes determining target audio data corresponding to a target timbre from candidate audio data respectively corresponding to N candidate timbres; obtaining first audio data and a first text corresponding to the first audio data, and encoding the first audio data and the first text to obtain an initial token sequence; when the first text comprises at least two languages, adding a language conversion token to the initial token sequence to obtain a first target token sequence; performing feature conversion on the first target token sequence based on the target audio data to obtain a first audio feature of the first target token sequence; and performing speech conversion on the first audio feature to obtain second audio data corresponding to the first text.

### CROSS-REFERENCE TO RELATED APPLICATION

The present disclosure claims foreign priority to Chinese Patent Application No. CN202411993615.9, titled “SPEECH DATA PROCESSING METHOD, SPEECH DATA PROCESSING DEVICE, ELECTRONIC DEVICE, AND COMPUTER-READABLE STORAGE MEDIUM”, filed on Dec. 30, 2024 in China National Intellectual Property Administration, and the entire contents of which are hereby incorporated by reference.

### TECHNICAL FIELD

The present disclosure relates to a field of computer technology, and in particular to a speech data processing method, a speech data processing device, an electronic device, and a non-transitory computer-readable storage medium.

### BACKGROUND

In a field of speech synthesis, generating natural-sounding voice typically requires voice samples from multiple speakers. Timbre unification technology for mixed speeches is adopted to synthesize more natural and consistent speeches, and timbre unification is a key step in speech synthesis. The timbre unification technology is configured to create personalized voice services, such as customized voice assistants and game character voice-overs. In a medical field, the timbre unification technology is configured to assist in diagnosis by analyzing changes in a timbre of a patient to diagnose certain diseases. In cultural and entertainment industries such as film, television series, and animation, the timbre unification technology is configured to create realistic and consistent voice effects.

However, in a process of speech synthesis, insufficient amount of data to satisfy timbre preferences leads to a lack of timbre richness. Furthermore, differences between training data from different languages result in variations in the timbre of synthesized speech and unnatural transitions, making it impossible to perform personalized timbre unification for speech data from different languages.

### SUMMARY

The present disclosure provides a speech data processing method, a speech data processing device, an electronic device, and a non-transitory computer-readable storage medium, which improve timbre diversity of speech data and are able to perform personalized timbre unification for the speech data of different languages.

In a first aspect, the present disclosure provides the speech data processing method. The speech data processing method comprises:
determining target audio data corresponding to a target timbre from candidate audio data respectively corresponding to N candidate timbres;
obtaining first audio data and a first text corresponding to the first audio data, and encoding the first audio data and the first text to obtain an initial token sequence;
when the first text comprises at least two languages, adding a language conversion token to the initial token sequence to obtain a first target token sequence;
performing feature conversion on the first target token sequence based on the target audio data to obtain a first audio feature of the first target token sequence; and
performing speech conversion on the first audio feature to obtain second audio data corresponding to the first text.

A timbre of the second audio data is the target timbre.

In a second aspect, the present disclosure provides the speech data processing device. The speech data processing device comprises a timbre determination module, a first marking module, a second marking module, a feature conversion module, and a speech conversion module.

The timbre determination module is configured to determine target audio data corresponding to a target timbre from candidate audio data respectively corresponding to N candidate timbres. The first marking module is configured to obtain first audio data and a first text corresponding to the first audio data, and is configured to encode the first audio data and the first text to obtain an initial token sequence. When the first text comprises at least two languages, the second marking module is configured to add a language conversion token to the initial token sequence to obtain a first target token sequence. The feature conversion module is configured to perform feature conversion on the first target token sequence based on the target audio data to obtain a first audio feature of the first target token sequence. The speech conversion module is configured to perform speech conversion on the first audio feature to obtain second audio data corresponding to the first text. A timbre of the second audio data is the target timbre.

In a third aspect, the present disclosure provides the electronic device. The electronic device comprises a memory and a processor. The memory is configured to store computer-executable instructions or a computer program. The processor is configured to implement the speech data processing method described above when executing the computer-executable instructions or the computer program stored in the memory.

In a fourth aspect, the present disclosure provides the non-transitory computer-readable storage medium. The non-transitory computer-readable storage medium comprises computer-executable instructions or a computer program stored thereon. When executed by a processor, the computer-executable instructions or the computer program implements the speech data processing method described above.

In the embodiments of the present disclosure, the target audio data corresponding to the target timbre from candidate audio data respectively corresponding to N candidate timbres is determined, which enables a determination of a personalized timbre from the audio data of different timbres. Then, the first audio data and the first text corresponding to the first audio data are obtained, and the first audio data and the first text are encoded to obtain the initial token sequence. When the first text comprises at least two languages, the language conversion token is added to the initial token sequence to obtain the first target token sequence. In this way, different languages in the first text are converted. The feature conversion is performed on the first target token sequence based on the target audio data to obtain the first audio feature of the first target token sequence. Furthermore, the speech conversion is performed on the first audio feature to obtain the second audio data corresponding to the first text. The timbre of the second audio data is the target timbre. In this way, by using audio data with personalized timbre to perform speech conversion on other audio data, personalized timbre unification of the speech data of different languages is realized.

### BRIEF DESCRIPTION OF DRAWINGS

FIG. 1 is a schematic diagram of an application mode of a speech data processing method according to one embodiment of the present disclosure.

FIG. 2 is a block diagram of an electronic device according to one embodiment of the present disclosure.

FIG. 3A is a flow chart of a speech data processing method according to one embodiment of the present disclosure.

FIG. 3B is another flow chart of the speech data processing method according to one embodiment of the present disclosure.

FIG. 3C is another flow chart of the speech data processing method according to one embodiment of the present disclosure.

FIG. 3D is another flow chart of the speech data processing method according to one embodiment of the present disclosure.

FIG. 4 is a flow chart of the speech data processing method according to one embodiment of the present disclosure.

FIG. 5 is a schematic diagram of a Mel spectrum diffusion process according to one embodiment of the present disclosure.

FIG. 6 is a schematic diagram of a speech tagging process according to one embodiment of the present disclosure.

FIG. 7 is a schematic diagram of a structures of an input sequence of the same language according to one embodiment of the present disclosure.

FIG. 8 is a schematic diagram of the structures of the input sequences of different languages according to one embodiment of the present disclosure.

It should be noted that terms “first” and “second” are used only to distinguish different options and do not represent the degree of superiority or inferiority of the options or their priority in the implementation process.

### DETAILED DESCRIPTION

In order to make the objectives, technical solutions, and characteristics of the present disclosure clear, the present disclosure is described in detail with reference to the accompanying drawings, and the described embodiments are not considered as limitations to the present disclosure, and all other embodiments obtained by those skilled in the art without creative efforts shall fall within the protection scope of the present disclosure.

In the description of the present disclosure, reference is made to “some embodiments”, which describe a subset of all possible embodiments, but it is to be understood that “some embodiments” may be the same subset or different subsets of all possible embodiments and may be combined with each other without conflict.

In the description of the present disclosure, the terms “first”, “second”, and “third” involved are for distinguishing similar objects, and do not represent a specific order for the similar objects. It is understood that the terms “first”, “second”, and “third” may be interchanged with a particular order or order when allowed, so that the embodiments of the present disclosure described herein can be implemented in an order other than illustrated or described herein.

In the embodiments of the present disclosure, the term “module” or “unit” refers to a computer program or a part of a computer program having a predetermined function, and works with other related parts to implement a predetermined target, and may be implemented completely or partially by using software, hardware (for example, a processing circuit or a memory), or a combination thereof. Similarly, a processor (or a plurality of processors or memories) may be configured to implement one or more modules or units. In addition, each module or each unit may be a part of an overall module or an overall unit having functions of each module or each unit.

Unless otherwise defined, all technical terms and scientific terms used in the embodiments of the present disclosure have the same meaning as commonly understood by those skilled in the art. Terms used in the embodiments of the present disclosure are merely intended to describe the objectives of the embodiments of the present disclosure, and are not intended to limit the present disclosure.

Before further describing the embodiments of the present disclosure in detail, the terms involved in the embodiments of the present disclosure are explained. The terms involved in the embodiments of the present disclosure are subject to the following interpretations.

1) Position encoding refers to a technique that introduces positional information of sequence elements into a sequence model.

2) Mel spectrum refers to a visualization tool configured to represent spectral characteristics of a speech signal and convert time and frequency dimensions of the speech signal into a two-dimensional image.

3) Timbre refers to quality or characteristics of sound, determined by various factors such as a spectral composition, a waveform shape, and a harmonic structure of the sound.

The present disclosure provides a speech data processing method, a speech data processing device, an electronic device, and a non-transitory computer-readable storage medium, which improve timbre diversity of speech data and are able to perform personalized timbre unification for the speech data of different languages.

The following describes exemplary applications of the electronic device provided in the embodiments of the present disclosure. The electronic device may be a terminal, such as a laptop, a tablet, a desktop computer, a set-top box, a smartphone, a smart speaker, a smartwatch, a smart TV, or an in-vehicle terminal. Alternatively, the electronic device may be a server. The following embodiments take an example that the electronic device is the server for further illustration.

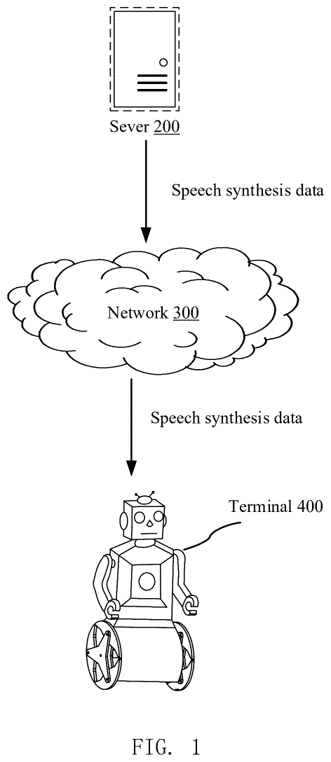

FIG. 1 is a schematic diagram of an application mode of a speech data processing method according to one embodiment of the present disclosure. As shown in FIG. 1, FIG. 1 discloses a server 200, a network 300, and a terminal 400. The terminal 400 is connected to the server 200 through the network 300. The network 300 may be a wide area network (WAN) or a local area network (LAN), or a combination thereof.

The present disclosure takes an example that the terminal 400 is an intelligent question-and-answer robot for further illustration. When the terminal 400 performs voice interaction, in response to a received audio selection operation, the terminal 400 determines target audio data corresponding to a target timbre from candidate audio data respectively corresponding to N candidate timbres. The terminal 400 collects speech data of an interactive object and performs speech recognition to obtain a question text. The terminal 400 then sends the question text to the server 200. The server 200 determines a response text based on the question text and sends the response text to terminal 400. The terminal 400 receives the response text and identifies the response text as the first text. Then, the terminal 400 obtains first audio data corresponding to the first text, and encodes the first audio data and the first text to obtain an initial token sequence. When the first text comprises at least two languages, the terminal 400 adds a language conversion token to the initial token sequence to obtain a first target token sequence. The terminal 400 further performs feature conversion on the first target token sequence based on the target audio data to obtain a first audio feature of the first target token sequence. Finally, the terminal 400 performs speech conversion on the first audio feature to obtain second audio data corresponding to the first text. A timbre of the second audio data is the target timbre. The second audio data is speech synthesis data. Therefore, the speech synthesis data is output.

In some embodiments, when the speech data processing method is realized by the server 200. After determining the target audio data, the terminal 400 sends the target audio data or a data identifier corresponding to the target audio data to the server 200, so that the server 200 performs subsequent timbre unification processing based on the target audio data. After collecting the speech data of the interactive object, the terminal 400 sends the speech data to the server 200. The server 200 performs speech recognition on the speech data to obtain the question text, then determines the response text based on the question text, and determines the response text as the first text. Then, the server 200 obtains the first audio data corresponding to the first text, and encodes the first audio data and the first text to obtain the initial token sequence. When the first text comprises at least two languages, the server 200 adds the language conversion token to the initial token sequence to obtain the first target token sequence. The server 200 further performs feature conversion on the first target token sequence based on the target audio data to obtain the first audio feature of the first target token sequence. Finally, the server 200 performs speech conversion on the first audio feature to obtain the second audio data corresponding to the first text. The timbre of the second audio data is the target timbre. The second audio data is the speech synthesis data. The server 200 sends the speech synthesis data to the terminal 400, and the terminal 400 outputs the speech synthesis data.

In some embodiments, the server 200 is an independent physical server, a server cluster or distributed system consisting of a plurality of physical servers, or a cloud server. The cloud server is configured to provide basic cloud computing services such as cloud services, cloud databases, cloud computing, cloud functions, cloud storage, network services, cloud communications, middleware services, domain name services, security services, content delivery networks (CDNs), and big data and artificial intelligence platforms. The terminal 400 may be, but is not limited to, a smartphone, a tablet computer, a laptop computer, a desktop computer, a smart speaker, a smartwatch, a smart voice interaction device, a smart home appliance, an in-vehicle terminal, an aircraft, etc. The terminal and the server are connected directly or indirectly via wired or wireless communication, which is not limited in the embodiments.

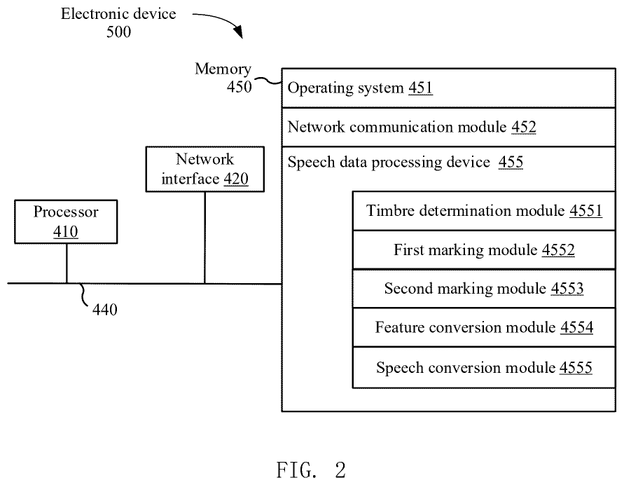

As shown in FIG. 2, FIG. 2 is a schematic diagram of an electronic device according to one embodiment of the present disclosure. The electronic device 500 shown in FIG. 2 may be the terminal 400 or the server 200 in FIG. 1. The electronic device 500 comprises at least one processor 410, a memory 450, at least one network interface 420, and a user interface 430. The various components in the electronic device are coupled together through a bus system 440. It is understood that the bus system 440 is configured to realize the connection and communication between the various components. In addition to a data bus, the bus system 440 further comprises a power bus, a control bus, and a status signal bus. However, for ease of illustration, various buses are comprised in the bus system 440 shown in FIG. 2.

The at least one processor 410 may be an integrated circuit chip having a signal processing capability, such as a general-purpose processor, a digital signal processor (DSP), or a programmable logic device, a discrete gate, or a transistor logic device, a discrete hardware component, etc. The general-purpose processor is a microprocessor or any conventional processor, etc.

The memory 450 may be removable, non-removable, or a combination thereof. For instance, the memory 450 may be a hardware device, such as a solid-state memory, a hard disk drive, an optical drive, etc. Optionally, the memory 450 comprises one or more storage devices physically located away from the at least one processor 410.

The memory 450 may comprise a volatile memory or a non-volatile memory, and may further comprise both the volatile memory and the non-volatile memory. The non-volatile memory may be a read-only memory (ROM), and the volatile memory may be a random access memory (RAM). The memory 450 described in the embodiments of the present disclosure is intended to comprise any suitable type of memory.

In some embodiments, the memory 450 is capable of storing data to support various operations, examples of which comprise programs, modules, and data structures or subsets or supersets thereof, as exemplified below.

An operating system 451 thereof comprises system programs configured to process various basic system services and perform hardware-related tasks, such as a framework layer, a core library layer, a driver layer, etc. The operating system 451 is further configured to realize various basic services and processing hardware-based tasks.

A network communication module 452 thereof is configured to communicate with other electronic devices via the at least one (wired or wireless) network interfaces 420. For instance, the at least one network interface 420 comprises a BLUETOOTH module, a wireless compatibility certification (WIFI), and a universal serial bus (USB).

In some embodiments, the speech data processing device in the embodiments of the present disclosure may be implemented in a software manner, and FIG. 2 shows the speech data processing device 455 stored in the memory 450. The speech data processing device 455 may be software in a form such as a program and a plugin. The speech data processing device 455 comprises a timbre determination module 4551, a first marking module 4552, a second marking module 4553, a feature conversion module 4554, and a speech conversion module 4555. These modules are logical and are able to be combined or further split according to functions to be implemented. Functions of these modules are described below.

The following will describe the speech data processing method provided by the present disclosure with reference to exemplary applications and implementations of the server provided in the embodiments of the present disclosure.

The following describes the speech data processing method provided in the embodiments of the present disclosure. Specifically, to facilitate understanding of the speech data processing method, the following describes application scenarios of the speech data processing method. When the intelligent question-and-answer robot (also defined as “the robot”) performs voice interaction, the robot needs to convert text information into natural and fluent speech and output the natural and fluent speech, so that the robot is able to communicate with a user in a way that is familiar to humans. The speech data processing method provided in the embodiments of the present disclosure improves the timbre diversity of the speech data and performs personalized timbre unification for the speech data of different languages.

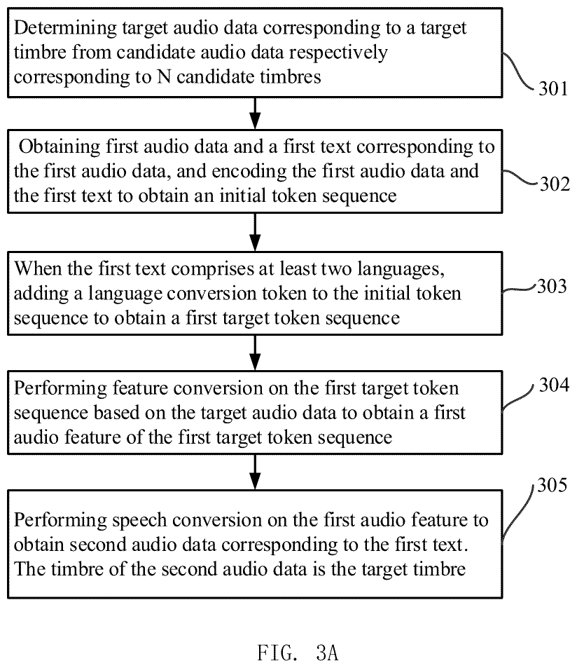

As mentioned above, the electronic device that implements the speech data processing method in the embodiment of the present disclosure may be the terminal, the server, or the combination of the two. The present disclosure takes an example that the electronic device is the server for further illustration. As shown in FIG. 3A. FIG. 3A is a flow chart of a speech data processing method according to one embodiment of the present disclosure. The speech data processing method comprises steps 301-305.

The step 301 comprises determining target audio data corresponding to a target timbre from candidate audio data respectively corresponding to N candidate timbres.

Specifically, each of the candidate timbres corresponds to one candidate audio data, and the target timbre refers to a timbre specified from the N candidate timbres.

FIG. 3B is another flow chart of the speech data processing method according to one embodiment of the present disclosure. Before performing the step 301, steps 3001-3003 are performed, which are described below.

The step 3001 comprises obtaining an initial text, and performing control symbol insertion and/or rewriting processing on the initial text to obtain a candidate text.

The initial text is configured to determine the candidate audio data and is obtained from a text dataset generated from historical voice interactions of the robot. The initial text is modified by inserting control symbols and performing rewriting processing to obtain the candidate text. The control symbols are labels configured to adjust the initial text. For example, the control symbols comprise [laugh] and [uv_break], where [laugh] represents laughter and [uv_break] represents a pause. When inserting the control symbols into the initial text, for example, when the initial text is “Hello, nice to meet you,” the candidate text after the control symbol insertion is “Hello [uv_break], nice to meet you [laugh].” In a speech synthesis result of the initial text after control symbol insertion, [laugh] is replaced by laughter, and a pause is added at [uv_break].

The control symbol insertion and/or the rewriting processing is performed based on the number of characters in the initial text. When the number of characters in the initial text is not less than a predetermined threshold, the control symbols are inserted. When the number of characters in the initial text is less than the predetermined threshold, the initial text is rewritten. When rewriting the initial text, a content of the initial text is reedited, and the number of characters in the initial text is increased or decreased. For example, the initial text is “I want to sleep,” and a rewritten text is “I just want to sleep.”.

The step 3002 comprises determining N candidate timbre parameters, and respectively inserting the N candidate timbre parameters into the candidate text to obtain N target texts.

The candidate timbre parameters comprise spectrum, spatial coordinates, and timbre number thereof. The candidate timbre parameters is understood as timbre seeds of the candidate timbres. Different candidate timbres correspond to different candidate timbre parameters. Cluster analysis is performed on different candidate timbres to obtain a category for each of the candidate timbres, and a corresponding candidate timbre parameter is assigned to each category. After determining the N candidate timbre parameters, each of the candidate timbre parameters is inserted into the candidate text, thereby obtaining the target texts. Each of the target texts comprises corresponding control symbols and a corresponding candidate timbre parameter.

The step 3003 comprises performing speech conversion on the N target texts to obtain the candidate audio data respectively corresponding to the N candidate timbres.

Specifically, the speech conversion is performed on each of the N target texts to obtain N candidate audio data. The N candidate audio data are respectively corresponding to the N candidate timbres.

In some embodiments, the step of performing speech conversion on the N target texts to obtain the candidate audio data respectively corresponding to the N candidate timbres comprises performing feature conversion respectively on the target texts to obtain first audio token sequences respectively corresponding to the target texts; performing feature extraction respectively on the first audio token sequences to obtain first audio features respectively corresponding to the first audio token sequences; and performing speech conversion respectively on the first audio features to obtain the candidate audio data.

Specifically, the feature conversion is performed, according to the control symbols in each of the target texts, on the target texts respectively to obtain the first audio token sequences. Optionally, when one of the target texts comprises a control symbol [empty_spk], which represents a pause, it indicates that the one of the target texts contains a pause feature. A pause feature conversion is performed on the one of the target texts to generate a corresponding discrete sequence audio_token, which is a corresponding first audio token sequence.

The feature extraction is performed on each of the first audio token sequences through an acoustic model to obtain a corresponding Mel-spectral feature, i.e., a corresponding first audio feature. Then, Mel-spectral features one-to-one corresponding to the first audio token sequences are obtained. The acoustic model may be a Diffusion Variational Autoencoder (DVAE) model, which combines a variational autoencoder and a generative model based on diffusion processes. For any one of the first audio token sequences of the target texts, the corresponding Mel-spectral feature is extracted by the DVAE model and is different from the Mel-spectral features of other first audio token sequences. The Mel-spectral features are converted into different waveforms by a vocoder model Vocos, thereby outputting the N candidate audio data corresponding to the N candidate timbres.

In the embodiment, by inserting the N candidate timbre parameters respectively into the candidate text, the N target texts are obtained. The speech conversion is then performed on the N target texts to obtain the N candidate audio data corresponding to the N candidate timbres, which improves the timbre diversity of the speech data, thereby providing diverse selections of personalized timbres.

As shown in FIG. 3A, the step 302 comprises obtaining first audio data and a first text corresponding to the first audio data, and encoding the first audio data and the first text to obtain an initial token sequence.

The first audio data is audio data to be converted in timbre, and the first text is a text corresponding to the first audio data. The first text is the response text obtained by intelligent question-and-answer processing of the question text. The first audio data and the first text are obtained from the text dataset generated from the historical voice interactions of the robot. The initial token sequence comprises an audio token sequence corresponding to the first audio data and a text token sequence corresponding to the first text.

FIG. 3C is another flow chart of the speech data processing method according to one embodiment of the present disclosure. In some embodiments, as shown in FIG. 3C, the encoding the first audio data and the first text to obtain the initial token sequence in the step 302 is realized by steps 3021-3024, which are described below.

The step 3021 comprises performing feature extraction on the first audio data to obtain a first audio feature, and performing position encoding on the first audio feature to obtain an audio representation vector.

A window function such as a Hamming window or a rectangular window is applied to divide the first audio data into overlapping frames to obtain frames of audio data. A Fast Fourier Transform is performed on each of the frames of audio data to convert a time-domain signal into a frequency-domain signal, so as to obtain a spectrum of each of the frames of audio data. Each spectrum of a corresponding one of the frames of audio data is input into a visualization tool and plotted as a two-dimensional. Then, a Mel spectrum including spectrums of the frames of audio data is obtained. The Mel spectrum is the first audio feature.

The first audio feature is positionally encoded by a first encoder. Each of frames of the first audio feature is assigned with a corresponding vector of a fixed size. Each vector represents a position of a corresponding frame in the first audio feature. Vectors of the frames are combined to form the audio representation vector. Specifically, the audio representation vector is represented by the following formula (1):

H1=Encoder1(posEnc(X)) (1)

H1 represents the audio representation vector. Encoder1 represents the first encoder. posEnc represents the positional encoding. X represents the first audio feature (the Mel spectrum).

The step 3022 comprises performing quantization processing on the audio representation vector to obtain a second audio token sequence.

The audio representation vector is quantized by a vector quantizer to obtain speech tokens one-to-one corresponding to the frames in the audio representation vector. The speech tokens of the frames are then combined into the second audio token sequence. Specifically, a speech token for an 1-th frame is represented by the following formula (2):

$$u = VQ ( {h}_{1} , C ) = {}_{mincn {∈}_{c}}^{arg} {‖ {h}_{1} - {c}_{n} ‖}^{2} \qquad ( 2 )$$

u represents the speech token of the 1-th frame. cₙ represents a speech vector of the 1-th frame in the audio representation vector. C represents a speech vector set. VQ represents the vector quantizer. h₁ represents a hidden layer representation of the 1-th frame.

In some embodiments, the speech vector of the 1-th frame is updated by an exponential moving average method. Specifically, an updated speech vector of the 1-th frame is represented by the following formula (3):

cᵤ₁=acᵤ₁+(1−a)h₁ (3)

cᵤ₁ represents the updated speech vector of the 1-th frame. a represents an attenuation coefficient. h₁ represents the hidden layer representation of the 1-th frame.

The updated speech vector of each of the frames is configured as a quantized hidden layer representation and combined with position coding as an input of the second encoder. Specifically, an output of the second encoder is determined by the following formula (4):

H3=Encoder2(PosEnc(H2)) (4)

H3 represents the output of the second encoder, Encoder2 represents the second encoder, posEnc represents the position encoding, and H2 represents the quantized hidden layer representation.

The step 3023 comprises encoding the first text to obtain a text token sequence.

Specifically, a byte pair encoding (BPE) model is constructed based on the text dataset. The first text is then encoded by the BPE model to convert a character sequence in the first text into a token sequence, thus obtaining the text token sequence.

The step 3024 comprises combining the second audio token sequence and the text token sequence to obtain the initial token sequence.

The second audio token sequence and the text token sequence are combined to obtain the initial token sequence. The initial token sequence is then configured as an input sequence for a large language model.

In some embodiments, the combining the second audio token sequence and the text token sequence to obtain the initial token sequence comprises concatenating the text token sequence after the second audio token sequence to obtain the initial token sequence.

The initial token sequence comprises a sequence start token, a text token sequence, a second audio token sequence, an additional information token (including control symbols, etc.), and a sequence end token. The sequence start token is located at a head portion of the initial token sequence, the second audio token sequence is concatenated after the sequence start token, the text token sequence is concatenated after the second audio token sequence, the additional information token is concatenated after the text token sequence, and the sequence end token is located at a tail portion of the initial token sequence.

As shown in FIG. 3A, the step 303 comprises when the first text comprises at least two languages, adding a language conversion token to the initial token sequence to obtain a first target token sequence.

Specifically, when the first text comprises the at least two languages, that is, the first text comprises different languages, the language conversion token is added to the initial token sequence to obtain the first target token sequence.

In some embodiments, the adding the language conversion token to the initial token sequence to obtain the first target token sequence comprises concatenating the language conversion token after the text token sequence to obtain the first target token sequence.

The first target token sequence comprises the sequence start token, the text token sequence, the second audio token sequence, the language conversion token, and the sequence end token. In the first target token sequence, the sequence start token is located at a head portion of the first target token sequence, the second audio token sequence is concatenated after the sequence start token, the text token sequence is concatenated after the second audio token sequence, the language conversion token is concatenated after the text token sequence, and the sequence end token is located at a tail portion of the first target token sequence.

In the embodiment, when the first text comprises the at least two languages, the first target token sequence is obtained by adding the language conversion token to the initial token sequence. Based on the first target token sequence, different languages in the first text are converted, thereby realizing personalized timbre unification of the speech data in different languages.

As shown in FIG. 3A, the step 304 comprises performing feature conversion on the first target token sequence based on the target audio data to obtain a first audio feature of the first target token sequence.

Specifically, the target audio data is encoded to obtain the target audio sequence. An optimal transmission path between the target audio sequence and the first target token sequence is calculated by an optimal transmission condition flow matching model. Based on the optimal transmission path, the first target token sequence is converted into the Mel spectrum, i.e., the first audio feature.

As shown in FIG. 3A, the step 305 comprises performing speech conversion on the first audio feature to obtain second audio data corresponding to the first text. The timbre of the second audio data is the target timbre.

In some embodiments, the step of performing speech conversion on the first audio feature to obtain the second audio data corresponding to the first text comprises: obtaining a generative adversarial network (GAN) model, calling the GAN model, and performing waveform extraction on the first audio feature to obtain a first audio waveform; determining, from an audio database, audio data matching the first audio waveform; and determining the audio data matching the first audio waveform as the second audio data corresponding to the first text.

The GAN model may be a vocoder network (HiFiGAN). A generator in the GAN model is called to generate an audio waveform of the first audio feature, i.e., the first audio waveform. After denoising and volume adjustment, the first audio waveform is matched with audio data in the audio database to obtain matching audio data. The matching audio data is saved as a WAV file and is determined as the second audio data corresponding to the first text.

FIG. 3D is another flow chart of the speech data processing method according to one embodiment of the present disclosure. In some embodiments, when the first audio data and the target audio data are of the same language, steps 310-314 are performed, which are described below.

The step 310 comprises when the first audio data and the target audio data are in the same language, encoding the target audio data to obtain a third audio token sequence.

When the first audio data and the target audio data are in the same language, the target audio data is divided into time frames by the window function. The fast Fourier transform and the Mel filtering are performed on the time frames to obtain Mel spectral features. The Mel spectral features are then converted into audio vectors to obtain the third audio token sequence.

The step 311 comprises determining a prompt word text corresponding to the target audio data, and encoding the prompt word text to obtain a prompt word token sequence.

Speech recognition is performed on the target audio data to obtain the prompt word text. Then, the prompt word text corresponding to the target audio data is encoded by a pre-trained embedding model, converting the prompt word text into text vectors. The text vectors are combined to obtain the prompt word token sequence.

The step 312 comprises inserting the third audio token sequence and the prompt word token sequence into the initial token sequence to obtain a second target token sequence.

The third audio token sequence and the prompt word token sequence are added to the initial token sequence to obtain the second target token sequence.

In some embodiments, the initial token sequence comprises the sequence start token, the text token sequence, the second audio token sequence, the additional information token (including control symbols, etc.), and the sequence end token. The sequence start token is located at the head portion of the initial token sequence, the second audio token sequence is concatenated after the sequence start token, the text token sequence is concatenated after the second audio token sequence, the additional information token is concatenated after the text token sequence, and the sequence end token is located at the tail portion of the initial token sequence. The step of inserting the third audio token sequence and the prompt word token sequence into the initial token sequence to obtain the second target token sequence is realized by inserting the prompt word token sequence after the second audio token sequence and before the text token sequence, and inserting the third audio token sequence after the text token sequence.

The second target token sequence comprises the sequence start token, the prompt word token sequence, the text token sequence, the second audio token sequence, the third audio token sequence, the additional information token, and the sequence end token. The sequence start token is located at a head portion of the second target token sequence, the second audio token sequence is concatenated after the sequence start token, the prompt word token sequence is concatenated after the second audio token sequence, the text token sequence is concatenated after the prompt word token sequence, the additional information token is concatenated after the text token sequence, the third audio token sequence is concatenated after the additional information token, and the sequence end token is located at a tail portion of the second target token sequence.

As shown in FIG. 3D, the step 313 comprises performing feature conversion on the second target token sequence based on the target audio data to obtain a second audio feature of the second target token sequence.

The target audio data is encoded to obtain the target audio sequence. The optimal transmission path between the target audio sequence and the second target token sequence is calculated by the optimal transmission condition flow matching model. Based on the optimal transmission path, the second target token sequence is converted into the Mel spectrum, which represents the second audio feature of the second target token sequence.

The step 314 comprises performing speech conversion on the second audio feature to obtain the second audio data corresponding to the first text.

The GAN model is invoked to perform waveform extraction on the second audio feature to obtain a second audio waveform. The second audio waveform is matched with the audio data in the audio database to obtain matching audio data, and the matching audio data is configured as the second audio data corresponding to the first text.

In the embodiment, when the first audio data and the target audio data are in the same language, the third audio token sequence and the prompt word token sequence corresponding to the target audio data are inserted into the initial token sequence to obtain the second target token sequence. Based on the second target token sequence, personalized timbre unification is realized for the speech data in the same language.

In some embodiments, the speech data processing method of the present disclosure is applied to a field of robot voice interaction. Specifically, the target audio data corresponding to the target timbre from candidate audio data respectively corresponding to N candidate timbres is determined, which enables a determination of a personalized timbre from the audio data of different timbres. Then, the first audio data and the first text corresponding to the first audio data are obtained, and the first audio data and the first text are encoded to obtain the initial token sequence. When the first text comprises at least two languages, the language conversion token is added to the initial token sequence to obtain the first target token sequence. In this way, different languages in the first text are converted. The feature conversion is performed on the first target token sequence based on the target audio data to obtain the first audio feature of the first target token sequence. Furthermore, the speech conversion is performed on the first audio feature to obtain the second audio data corresponding to the first text. The timbre of the second audio data is the target timbre. In this way, by using audio data with personalized timbre to perform speech conversion on other audio data, personalized timbre unification of the speech data of different languages is realized by the robot.

An exemplary application of the speech data processing method provided in the embodiments of the present disclosure in scenarios of robot voice interaction.

With advancement of robotic technology, endowing robots with voice interaction capabilities has become a focal point in research and development, as it contributes to improving the usability of robots and enhancing user experience. In robotic voice interaction systems, speech synthesis technology plays a crucial role. The speech synthesis technology aims to convert textual information into natural and fluent speech, enabling the robots to communicate with the users in a manner familiar to humans.

Early-stage speech synthesis technologies primarily rely on rule-based synthesis and parametric synthesis. The rule-based synthesis synthesizes speech through manually defined linguistic rules, but the resulting speech lacks naturalness and has limited adaptability. The parametric synthesis speech by modeling parameters of speech signals, which, while improving speech quality to some extent, still suffers from limitations such as monotonous timbre and insufficient expressiveness. With the emergence of statistical parametric speech synthesis (STP), which statistically analyzes and models large amounts of speech data, more natural and fluent speech synthesis is realized. However, limitations remain when handling complex texts and emotional expressions. In recent years, breakthroughs in speech synthesis technology have been driven by development of deep learning. Speech synthesis based on deep neural networks is able to automatically learn feature representations of speech, thereby improving naturalness and expressiveness of the synthesized speech.

The voice interaction systems essentially constitute a cascade model including an acoustic model and a vocoder. For example, deep learning models such as Recurrent Neural Networks (RNN) and Long Short-Term Memory (LSTM) networks are able to better process long sequences of speech data, enabling the training of more coherent speech synthesis models. Additionally, incorporating technologies such as the GAN as vocoders further enhances the quality and realism of the synthesized speech.

A speech synthesis process in the related art has following problems.

1) Different users have different needs, such as different timbre preferences. A timbre of the synthesized speech is influenced by training data, such as gender, voice tone, and speaking style of the training data. Furthermore, there is a shortage of data that meets these timbre preferences.

2) In robot voice interaction, multilingual support is a significant challenge for the speech synthesis technology. Differences in training data of different languages lead to inconsistent timbres and unnatural transitions in an output of the trained speech synthesis model, which prevents the robot from effectively communicating with users from different regions. Unifying the timbres in mixed Chinese and English speech is also a problem that urgently needs to be solved.

The related art suffers from limited training data and a lack of rich timbre, resulting in fewer timbres in the speech synthesis of the robots. There is further a problem of differences in the timbres of the synthesized speech and unnatural transitions caused by differences in mixed speech (such as Chinese and English) and the lack of training data. To solve the problems in the related art, the present disclosure a speech data processing method that, compared to related art, comprises the following improvements.

1) By setting the timbre seeds (the aforementioned candidate timbres), a text-to-speech model chatTTS generates diverse timbre data.

2) Based on a user-selected personalized timbre, the speech synthesis model CosyVoice replicates prosody of the user-selected personalized timbre or clones the user-selected personalized timbre across languages, thereby realizing timbre uniformity between personalized Chinese and English speeches.

In the embodiment, by combining the speech data with different timbres and the speech synthesis model, diverse personalized timbres are obtained for the user to choose from. Then, the speech with the user-selected personalized timbre is replicated or cloned across languages, and generated speech data is used in the speech synthesis model on the robot. In this way, the robot is enabled to realize timbre uniformity between personalized Chinese and English speeches during voice interaction, thereby improving the voice interaction capabilities of the robot.

1) By setting timbre seeds (the aforementioned candidate timbre parameters), the text-to-speech model chatTTS generates diverse timbre data.

2) Based on the user-selected personalized timbre, the speech synthesis model CosyVoice replicates the prosody of the personalized timbre or clones it across languages, thereby realizing timbre uniformity between personalized Chinese and English speech.

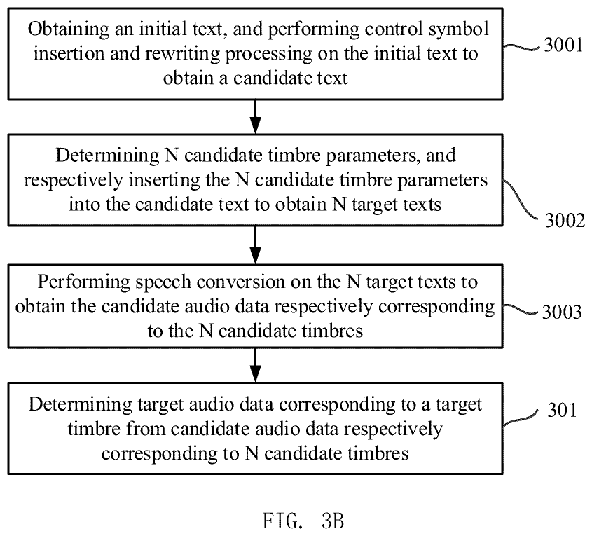

FIG. 4 is a flow chart of the speech data processing method according to one embodiment of the present disclosure. The electronic device implementing the speech data processing method of the embodiments of the present disclosure is the server. A speech data processing process of the embodiments of the present disclosure is described in conjunction with steps 401-413 shown in FIG. 4.

The step 401 comprises determining whether to insert control symbols into an input text.

It is determined whether to insert the control symbols into the input text. The control symbols are configured to adjust the text content. For example, the control symbols comprise [laugh] and [uv_break] that respectively represent laughter and pauses. In a synthesized speech of a text with control symbols “Hello [uv_break], nice to meet you [laugh]”, [laugh] is replaced with laughter, and a pause is added at [uv_break].

When it is determined to insert the control symbols into the input text, the Llama model is configured to insert the control symbols such as [uv_break] and [laugh] to obtain the text with control symbols. When the input text is not inserted with the control symbols, the speech data processing process proceeds to the step 402. The step 402 comprises determining whether to redefine the input text, i.e., regenerating the text content of the input text. For example, when the input text is “I want to sleep”, a redefined text may be “I just want to sleep”.

The step 403 comprises converting the text containing the control symbols and a timbre seed number into a discrete sequence ‘audio_token’.

The text containing the control symbols and the timbre seed number is converted into the discrete sequence ‘audio_token’ through the Llama model. The Llama model determines whether to perform a conversion operation based on the control symbols in the text. For example, when a control symbol ‘[empty_spk]’ is inserted before or after information representing speech in the text, it is equivalent to adding a pause symbol, indicating a pause in that speech information. The Llama model performs feature conversion on the text, turning the text content into the discrete sequence, and the discrete sequence is called ‘audio token’.

The step 404 comprises converting the discrete sequence ‘audio_token’ into Mel spectral features.

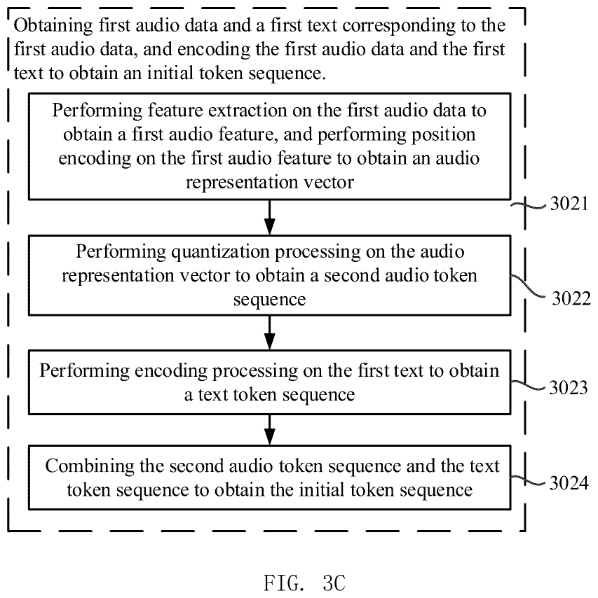

The discrete sequence ‘audio_token’ is converted into the Mel spectrum features ‘mel_spec’ by a diffusion variational encoder model (DVAE), i.e., the acoustic model. The DVAE model combines a variational autoencoder (VAE) and a generative model of the diffusion process. By learning a latent distribution of the speech data, the DVAE model generates new speech data samples, including modeling a diffusion process and learning latent variables, and is able to generate speech data with various timbres. For example, as shown in FIG. 5, which is a schematic diagram of a Mel spectrum diffusion process according to one embodiment of the present disclosure. A Mel spectrum X₀ is obtained by diffusion sampling, and a Mel spectrum Xₜ is obtained by diffusion sampling of a Mel spectrum Xₜ₋₁.

As shown in FIG. 4, the step 405 comprises outputting speech.

The vocoder model Vocos is used to perform speech conversion on the converted Mel spectrum features. Since the acoustic model generates various different Mel spectrum features, the vocoder model converts the Mel spectrum features into waveforms to derive speech with different timbres for the user to choose from. Personalized speech is customized based on the user's selected timbre, and speech data of other languages is replicated or cloned across languages based on the personalized speech.

Step 406 comprises marking the speech.

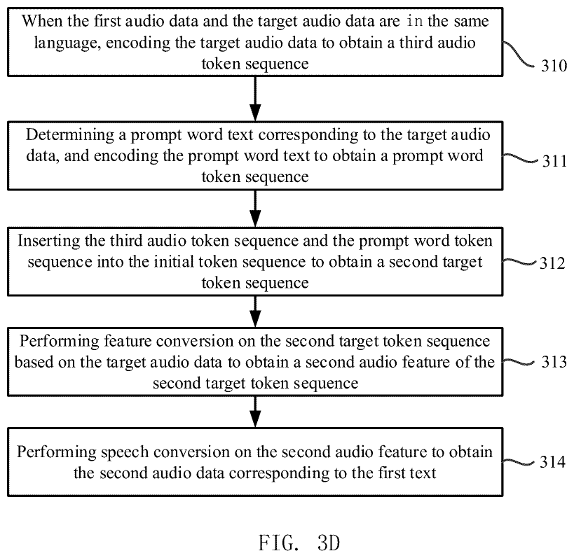

FIG. 6 is a schematic diagram of a speech marking process according to one embodiment of the present disclosure. A vector quantization layer is inserted between a first encoder 601 and a second encoder 603 to extract the Mel spectral features from the input speech, thereby obtaining a Mel spectrum. The Mel spectrum is configured as an input of the first encoder 601 and is encoded in combination with positional encoding to obtain a context-aware representation (the audio representation vector described above). Specifically, the context-aware representation is determined by the following formula (1).

H1=Encoder1(posEnc(X)) (1)

H1 represents context-aware representation. Encoder1 represents the first encoder, posEn represents position encoding, and X represents the Mel spectrum.

A discrete token is obtained through a vector quantizer 602, and combined with the audio representation vector, a speech token for an 1-th frame is obtained. For example, the speech tokens for the 1-th frame is determined by the following formula (2):

$$u = VQ ( {h}_{1} , C ) = {}_{mincn {∈}_{c}}^{arg} {‖ {h}_{1} - {c}_{n} ‖}^{2} \qquad ( 2 )$$

u represents the speech token of an 1-th frame. cₙ represents a speech vector of the 1-th frame in the audio representation vector. C represents a speech vector set. VQ represents the vector quantizer. h₁ represents a hidden layer representation of the 1-th frame.

The speech vectors are updated during training, which are updated by an exponential moving average method. Specifically, an updated speech vector of the 1-th frame is determined by the following formula (3).

cᵤ₁=acᵤ₁+(1−a)h₁ (3)

cᵤ₁ represents the updated speech vector of the 1-th frame. a represents an attenuation coefficient. h₁ represents the hidden layer representation of the 1-th frame.

Updated speech vector of all of the frames are configured as the quantized hidden layer representation H2={cᵤ₁, cᵤ₂, . . . }, and is combined with the positional encoding as the input of the second encoder. Specifically, an output of the second encoder is determined by the following formula (4):

H3=Encoder2(PosEnc(H2)) (4)

H3 represents the output of the second encoder, Encoder2 represents the second encoder, posEnc represents the position encoding.

The output of the second encoder is configured as an input to an Automatic Speech Recognition (ASR) decoder. In the ASR decoder 604, an output thereof is a posterior probability P(Y|X) of a text token corresponding to the speech. The posterior probability refers to a probability that a speech signal corresponds to a certain text token, that is, a probability of each word appearing in the content of the speech.

As shown in FIG. 4, the step 407 comprises encoding the text.

The input text is encoded by Byte Pair Encoding (BPE) to obtain text vectors.

The step 408 comprises aligning the text vectors and the speech tokens.

Specifically, the speech tokens are one-to-one aligned with the text vectors to obtain a sequence composed of the text vectors and the speech tokens.

The step 409 comprises learning the sequence composed of the text vectors and the speech tokens.

An input sequence configured to construct a large language model. The input sequence mainly comprises a sequence start token, extracted speech embedding vectors, the text vectors, and a sequence end token. Since the text vectors and the speech tokens are at different semantic levels, each of start mark symbols is inserted between each of the text vectors corresponding speech tokens. During training, an original sequence is configured as an expected output, and only a cross-entropy loss of the speech tokens and the sequence end token is considered during training to obtain the sequence composed of the speech tokens and the text vectors. Specifically, the cross-entropy loss is determined by the following formula (5):

$${L}_{LM} = - \frac{1}{L + 1} {\sum }_{i = 1}^{L + 1} log q ( {u}_{1} ) \qquad ( 5 )$$

LLM represents the cross-entropy loss. q(u₁) represents the posterior probability (predicted by a normalized softmax layer of the large language model).

The step 411 comprises adjusting the speech tokens in the input sequence based on a reference timbre.

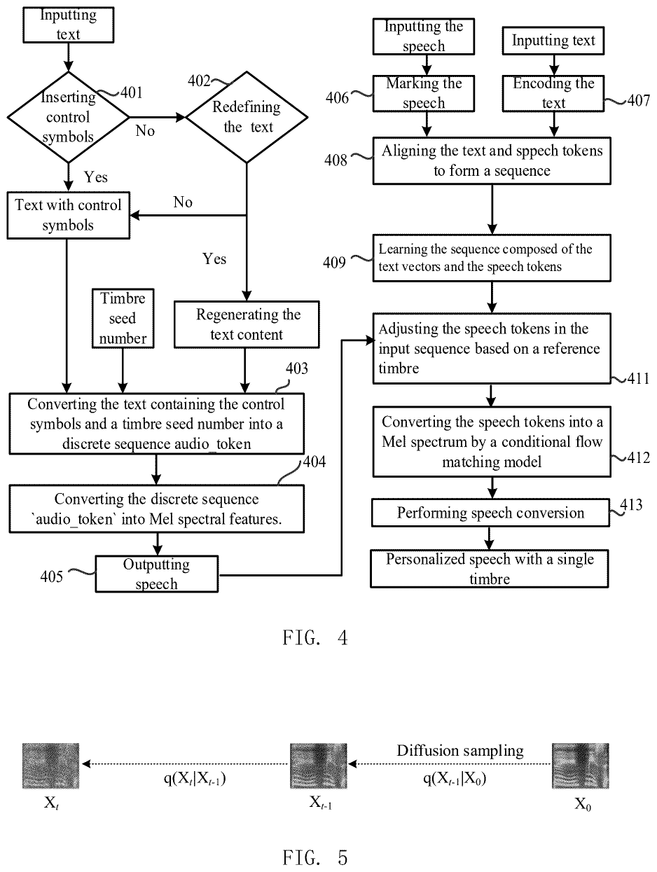

A user-selected personalized speech is configured as a reference speech. When the reference speech and the input speech are in the same language, the context learning zero-shot of the large language model is configured to replicate a timbre of the reference speech by using a short reference speech sample. During the process, the input sequence of the large language model is constructed according to actual needs, merging the reference speech token (Prompt Speech Token, which is the third audio token sequence mentioned above) and a prompt speech text token (Prompt Text, which is the prompt word token sequence mentioned above) into a unified input sequence. The prompt speech token is pre-generated, and subsequent tokens are predicted by an autoregressive language model. For example, referring to FIG. 7, FIG. 7 is a schematic diagram of the structure of the input sequence of the same language according to one embodiment of the present disclosure. The input sequence of the same language comprises the input speech 701, the prompt speech text 702, the input text 703, and the reference speech 704.

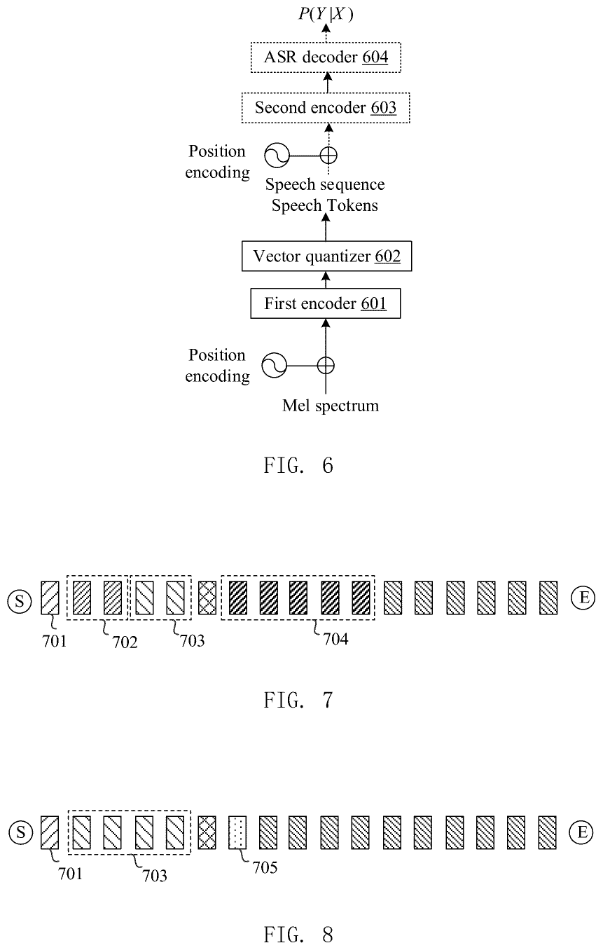

When the reference speech (the target audio data mentioned above) and the input speech (the first audio data mentioned above) are in different languages, i.e., the cross-language cloned sequence composition does not require the reference speech and prompt text, but requires the insertion of a language conversion token (LID). The remaining structure of the input sequence is consistent with the input sequence of the same language. FIG. 8 is a schematic diagram of the structures of the input sequences of different languages according to one embodiment of the present disclosure. For example, the input sequence of different languages comprises the input speech 701, the input text 703, and the language conversion token 705.

As shown in FIG. 4, the step 412 comprises converting the speech tokens into a Mel spectrum by a conditional flow matching model.

A principle of conditional flow matching model (OT-FCM) is to construct a probability density path from the prior distribution p(x) to the Mel spectrum q(x) in a continuous-time normalized flow. The probability density path is represented by a time-dependent vector field. Specifically, the probability density path is determined by the following formula (6):

$$\{ \begin{matrix}\frac{d}{dt} {\text{?}}_{t} ( X ) = {v}_{t} ( {\text{?}}_{t} ( X ) , t ) \\ {\text{?}}_{0} ( X ) {}^{∼} {P}_{0} ( X ) = N ( X ; 0 , I ) \\ {\text{?}}_{1} ( X ) {}^{∼} {P}_{1} ( X )\end{matrix} \qquad ( 6 )$$

t ranges from 0 to 1, and the initial value problem equation is solved. The Mel spectrum q(x) is approximated by the prior distribution p(x) and the prior distribution p(x) samples from the Mel spectrum q(x). The time-dependent vector field is learned through the optimal transport condition flow. Specifically, a minimized loss is determined by the following formulas (7)-(9):

$${L}_{OT - CFM} = {E}_{t , p 0 ( x ) , q ( x )} {w}_{t} ( {\text{?}}_{t}^{0 T} ( X 0 , X 1 ) \vert X 1 ) - {v}_{t} ( {\text{?}}_{t}^{0 T} ( X 0 , X 1 ) \vert X 1 ) \qquad ( 7 )$$

$${\text{?}}_{t}^{0 T} ( X 0 , X 1 ) = ( 1 - ( 1 - σ ) t ) X 0 + tX 1 \qquad ( 8 )$$

$${w}_{t} ( {\text{?}}_{t}^{0 T} ( X 0 , X 1 ) \vert X 1 ) = X 1 - ( 1 - σ ) X 0 \qquad ( 9 )$$

The extracted speech embedding vectors, the speech tokens, and the Mel spectrum are all input into a neural network to match the time-dependent vector field with learnable parameters. Specifically, the time-dependent vector field can be determined by the following formula (10):

$${v}_{t} ( {\text{?}}_{t}^{0 T} ( X 0 , X 1 ) \vert θ ) + {NN}_{θ} ( {\text{?}}_{t}^{0 T} ( X 0 , X 1 ) , t ; v , {\{ {u}_{1} \}}_{1 : L} , X {1}^{′} ) \qquad ( 10 )$$

As shown in FIG. 4, the step 413 comprises performing speech conversion.

The Mel spectrum is configured as an input to the vocoder to be converted into personalized speech with a single timbre. The vocoder is a HiFiGAN, which realizes personalized speech output with consistent timbre in both Chinese and English.

In the above application scenario of robot voice interaction, by applying the chatTTS model and the CosyVoice model to the speech synthesis model of the robot, a speech synthesis effect is improved. The speech data processing process enables the user to select different timbres while outputting the single timbre across different languages, including Chinese and English. In this way, the robot is able to exhibit a more natural, realistic, and emotionally resonant personalized speech during voice interaction. When the output speech includes Chinese and English, the timbre is naturally transitioned without changing, which provides a solution for personalized timbre customization and timbre unification in mixed languages for the robot voice interaction, thereby significantly improving the interactive capabilities of the robot.

The following embodiments of the present disclosure further illustrate an exemplary structure of the speech data processing device 455 configured as a software module. As shown in FIG. 2, the speech data processing device 455 comprises a timbre determination module 4551, a first marking module 4552, a second marking module 4553, a feature conversion module 4554, and a speech conversion module 4555.

The timbre determination module 4551 is configured to determine target audio data corresponding to a target timbre from candidate audio data respectively corresponding to N candidate timbres. The first marking module 4552 is configured to obtain first audio data and a first text corresponding to the first audio data, and is configured to encode the first audio data and the first text to obtain an initial token sequence. When the first text comprises at least two languages, the second marking module 4553 is configured to add a language conversion token to the initial token sequence to obtain a first target token sequence. The feature conversion module 4554 is configured to perform feature conversion on the first target token sequence based on the target audio data to obtain a first audio feature of the first target token sequence. The speech conversion module 4555 is configured to perform speech conversion on the first audio feature to obtain second audio data corresponding to the first text. A timbre of the second audio data is the target timbre.

In some embodiments, the timbre determination module 4551 is configured to obtain an initial text, and performing control symbol insertion and/or rewriting processing on the initial text to obtain a candidate text, determine N candidate timbre parameters, and respectively inserting the N candidate timbre parameters into the candidate text to obtain N target texts, and perform speech conversion on the N target texts to obtain the candidate audio data respectively corresponding to the N candidate timbres.

In some embodiments, the timbre determination module 4551 is further configured to perform feature conversion respectively on the target texts to obtain first audio token sequences respectively corresponding to the target texts, perform feature extraction respectively on the first audio token sequences to obtain first audio features respectively corresponding to the first audio token sequences; and perform speech conversion respectively on the first audio features to obtain the candidate audio data.

In some embodiments, the first marking module 4552 is further configured to perform feature extraction on the first audio data to obtain a first audio feature, and performing position encoding on the first audio feature to obtain an audio representation vector, perform quantization processing on the audio representation vector to obtain a second audio token sequence, perform encoding processing on the first text to obtain a text token sequence, and combine the second audio token sequence and the text token sequence to obtain the initial token sequence.

In some embodiments, the first marking module 4552 is further configured to concatenate the text token sequence after the second audio token sequence to obtain the initial token sequence and concatenate the language conversion token to the text token sequence to obtain the first target token sequence.

In some embodiments, the speech conversion module 4555 is further configured to obtain a generative adversarial network model, call the generative adversarial network model, perform waveform extraction on the first audio feature to obtain a first audio waveform, determine from an audio database, audio data matching the first audio waveform, and determine the audio data matching the first audio waveform as the second audio data corresponding to the first text.

In some embodiments, when the first audio data and the target audio data are in the same language, the speech conversion module 4555 is further configured to encode the target audio data to obtain a third audio token sequence, determine a prompt word text corresponding to the target audio data, encode the prompt word text to obtain a prompt word token sequence, insert the third audio token sequence and the prompt word token sequence into the initial token sequence to obtain a second target token sequence, perform feature conversion on the second target token sequence based on the target audio data to obtain a second audio feature of the second target token sequence, and perform speech conversion on the second audio feature to obtain the second audio data corresponding to the first text.

In some embodiments, the initial token sequence comprises the second audio token sequence and the text token sequence, and the second audio token sequence is located before the text token sequence. The speech conversion module 4555 is further configured to insert the prompt word token sequence after the second audio token sequence and before the text token sequence, and insert the third audio token sequence after the text token sequence to obtain the second target token sequence.

The embodiments of the present disclosure provide a computer program product. The computer program product comprises a computer program or computer-executable instructions, and the computer program or the computer-executable instructions are stored in a non-transitory computer-readable storage medium. The at least one processor of the electronic device reads the computer-executable instructions from the non-transitory computer-readable storage medium, and the at least one processor executes the computer-executable instructions, so that the electronic device performs the speech data processing method of the embodiments of the present disclosure.

The embodiments of the present disclosure further provide the non-transitory computer-readable storage medium. The non-transitory computer-readable storage medium comprises the computer-executable instructions stored thereon or the computer program stored thereon. The computer-executable instructions or the computer program is executed by at least one processor to implement the speech data processing method as shown in FIG. 3A according to the embodiments of the present disclosure.

In some embodiments, the non-transitory computer-readable storage medium may be the memory, such as the RAM, the ROM, the flash memory, a magnetic surface memory, an optical disk, a CD-ROM, or other devices including one or any combination of the above memories.

In some embodiments, the computer-executable instructions are in the form of a program, a software, a software module, a script, or codes, written in any form of programming language (including compiled or interpreted languages, or declarative or procedural languages), and are deployed in any form, including being deployed as an independent program or as a module, a component, a subroutine, or other unit suitable for use in a computing environment.

As an example, the computer-executable instructions may, but not necessarily, correspond to a file in a file system. Instead, the computer-executable instructions are stored as parts of a file storing other programs or data. For instance, the computer-executable instructions are stored in one or more scripts in a hypertext markup language (HTML) document, in a single file dedicated to the program in question, or are stored in multiple collaborative files (e.g., files storing one or more modules, subroutines, or code portions).

As an example, the computer-executable instructions are deployed to be executed on the electronic device, or on a plurality of electronic devices located at one location. Alternatively, the computer-executable instructions are executed on electronic devices disposed at multiple locations and interconnected by a communication network.

The above description is only optional embodiments of the present disclosure and is not intended to limit the protection scope of the present disclosure. Any modifications, equivalent substitutions, improvements, etc. made within the spirit and scope of the present disclosure are comprised in the protection scope of the present disclosure.

What is claimed is:

1. A speech data processing method, comprising:
determining target audio data corresponding to a target timbre from candidate audio data respectively corresponding to N candidate timbres;
obtaining first audio data and a first text corresponding to the first audio data, and encoding the first audio data and the first text to obtain an initial token sequence;
when the first text comprises at least two languages, adding a language conversion token to the initial token sequence to obtain a first target token sequence;
performing feature conversion on the first target token sequence based on the target audio data to obtain a first audio feature of the first target token sequence; and
performing speech conversion on the first audio feature to obtain second audio data corresponding to the first text, wherein a timbre of the second audio data is the target timbre.

2. The speech data processing method according to claim 1, wherein before determining the target audio data corresponding to the target timbre from the candidate audio data respectively corresponding to the N candidate timbres, the speech data processing method further comprises:
obtaining an initial text, and performing control symbol insertion and/or rewriting processing on the initial text to obtain a candidate text;
determining N candidate timbre parameters, and respectively inserting the N candidate timbre parameters into the candidate text to obtain N target texts; and
performing speech conversion on the N target texts to obtain the candidate audio data respectively corresponding to the N candidate timbres.

3. The speech data processing method according to claim 2, wherein the performing speech conversion on the N target texts to obtain the candidate audio data respectively corresponding to the N candidate timbres comprises:
performing feature conversion respectively on the target texts to obtain first audio token sequences respectively corresponding to the target texts;
performing feature extraction respectively on the first audio token sequences to obtain first audio features respectively corresponding to the first audio token sequences; and
performing speech conversion respectively on the first audio features to obtain the candidate audio data.

4. The speech data processing method according to claim 1, wherein the encoding the first audio data and the first text to obtain the initial token sequence comprises:
performing feature extraction on the first audio data to obtain a first audio feature, and performing position encoding on the first audio feature to obtain an audio representation vector;
performing quantization processing on the audio representation vector to obtain a second audio token sequence;
encoding the first text to obtain a text token sequence; and
combining the second audio token sequence and the text token sequence to obtain the initial token sequence.

5. The speech data processing method according to claim 4, wherein the combining the second audio token sequence and the text token sequence to obtain the initial token sequence comprises:
concatenating the text token sequence after the second audio token sequence to obtain the initial token sequence;
wherein the adding the language conversion token to the initial token sequence to obtain the first target token sequence comprises:
concatenating the language conversion token to the text token sequence to obtain the first target token sequence.

6. The speech data processing method according to claim 1, wherein the performing speech conversion on the first audio feature to obtain the second audio data corresponding to the first text comprises:
obtaining a generative adversarial network model, calling the generative adversarial network model, and performing waveform extraction on the first audio feature to obtain a first audio waveform; and
determining, from an audio database, audio data matching the first audio waveform, and determining the audio data matching the first audio waveform as the second audio data corresponding to the first text.

7. The speech data processing method according to claim 1, wherein the speech data processing method further comprises:
when the first audio data and the target audio data are of the same language, encoding the target audio data to obtain a third audio token sequence;
determining a prompt word text corresponding to the target audio data, and encoding the prompt word text to obtain a prompt word token sequence;
inserting the third audio token sequence and the prompt word token sequence into the initial token sequence to obtain a second target token sequence;
performing feature conversion on the second target token sequence based on the target audio data to obtain a second audio feature of the second target token sequence; and
performing speech conversion on the second audio feature to obtain the second audio data corresponding to the first text.

8. The speech data processing method according to claim 7, wherein the initial token sequence comprises the second audio token sequence and the text token sequence, and the second audio token sequence is located before the text token sequence,
wherein the inserting the third audio token sequence and the prompt word token sequence into the initial token sequence to obtain the second target token sequence comprises:
inserting the prompt word token sequence after the second audio token sequence and before the text token sequence, and inserting the third audio token sequence after the text token sequence to obtain the second target token sequence.

9. A speech data processing device, comprising:
a timbre determination module;
a first marking module;
a second marking module;
a feature conversion module; and
a speech conversion module;
wherein the timbre determination module is configured to determine target audio data corresponding to a target timbre from candidate audio data respectively corresponding to N candidate timbres;
wherein the first marking module is configured to obtain first audio data and a first text corresponding to the first audio data, and is configured to encode the first audio data and the first text to obtain an initial token sequence;
wherein when the first text comprises at least two languages, the second marking module is configured to add a language conversion token to the initial token sequence to obtain a first target token sequence;
wherein the feature conversion module is configured to perform feature conversion on the first target token sequence based on the target audio data to obtain a first audio feature of the first target token sequence;
wherein the speech conversion module is configured to perform speech conversion on the first audio feature to obtain second audio data corresponding to the first text;
wherein a timbre of the second audio data is the target timbre.

10. An electronic device, comprising:
a memory configured to store computer-executable instructions or a computer program; and
a processor;
wherein the processor is configured to implement the speech data processing method according to claim 1 when executing the computer-executable instructions or the computer program stored in the memory.

11. A non-transitory computer-readable storage medium, comprising:
computer-executable instructions or a computer program stored thereon;
wherein when executed by a processor, the computer-executable instructions or the computer program implements the speech data processing method according to claim 1.
